(19) United States
(12) Patent Application Publication
(10) Pub. No.: US 2009/0217279 A1
(43) Pub. Date: Aug. 27, 2009

(54) Method and Device for Controlling a Computer System

(75) Inventors: Reinhard Weiberle, Vaihingen/Enz (DE); Bernd Mueller, Leonberg-Silberberg (DE); Eberhard Boehl, Reutlingen (DE); Yorck von Collani, Beilstein (DE); Rainer Gmehlich, Ditzingen (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 11/988,485

(22) PCT Filed: Jul. 26, 2006
(86) PCT No.: PCT/EP2006/064672

§ 371 Date: Feb. 26, 2009

(30) Foreign Application Priority Data
Aug. 8, 2005 (DE) 10 2005 037 216.3

(51) Int. Cl. G06F 9/50

(52) U.S. Cl. 718/104

(57) ABSTRACT

A method and device for controlling a computer system having at least two execution units, a switchover taking place between at least two operating modes, and a first operating mode corresponds to a compare mode, and a second operating mode corresponds to a performance mode, wherein at least one set of run-time objects is defined, and a control program is provided, in particular a scheduler, which assigns resources of the computer system to the run-time objects as a function of an item of information regarding the operating mode.

### BACKGROUND INFORMATION

In the field of embedded systems such as automotive technology or automation technology, there are applications in which an error in the μC hardware can have potentially safety-relevant consequences. In order to avoid these consequences or to reduce the severity of the effects, monitoring measures for detecting errors are employed. Some applications require such monitoring on a virtually permanent basis; in other applications there are monitoring functions that check as to whether the computer or also other components are still functioning properly on a regular basis (i.e., periodically) or upon specific requests.

The present invention provided here is related to German Patent Application No. DE 103 32 700 A1. There, a method and a device for a switchover between two operating modes of a processor unit are described. The processor unit has at least two execution units, and the different operating modes have as their goal the possibility of the processor unit operating in at least one so-called performance mode as well as in a so-called compare mode (CM). In performance mode, different programs are executed on, for example, two execution units. In compare mode, on the other hand, identical programs are executed on both execution units, and the results of both execution units are compared to one another and an error signal is triggered in the event of a discrepancy. From the aspect of processing capacity, it is basically advantageous to have as many tasks as possible running in the most productive mode (performance mode). On the other hand, virtually all tasks are computed with excellent error detection, especially in safety-relevant applications. That is to say, in the related art it is therefore difficult or impossible to utilize a large portion of the computing capacity of a performance mode.

There are applications that impose relative complex demands on error detection. In many control engineering applications, for example, an error that acts only briefly is tolerated by the application itself, so that there is no required error detection for transient fault at many locations. However, this requirement does exist for permanent errors. Nevertheless, the related art offers no generally feasible options for resolving this specification conflict in a cost-effective manner.

The time required for the switchover between the different operating modes (performance mode, compare mode) is not negligible. In very frequent switchovers, this overhead needs to be taken into account. In order to allow optimal strategies to be pursued in a scheduling problem, the initiation of more frequent switching of tasks also on short notice is required from the aspect of the application software.

### SUMMARY

An object of the present invention is to allow an optimization of the number of switchover operations to be implemented between the modes and to save computing time in this manner.

It is also an object of the present invention to utilize the potential performance gain of a mode as best as possible, i.e., to use as much computer capacity as possible in a performance mode.

An example method for controlling a computer system having at least two execution units is advantageously employed, a switchover taking place between at least two operating modes, and a first operating mode corresponds a compare mode, and a second operating mode corresponds to a performance mode, characterized in that at least one set of run-time objects is defined and a control program is provided, in particular a scheduler, which allocates resources of the computer system to the run-time objects as a function of an item of operating mode information.

An example method may advantageously be employed in which at least one identifier is assigned to each run-time object of the defined set, and the identifier assigns at least the two operating modes to the run-time object.

An example method may advantageously be employed in which items of information regarding an instantaneous operating mode of the computer system are available and the control program takes these into account in allocating the resources.

An example method may advantageously be employed in which items of information regarding a future operating mode of the computer system are available and the computer program takes these into account in allocating the resources.

An example method may advantageously be employed in which the control program evaluates the identifier.

An example method may advantageously be employed in which the control program assigns at least one priority to the run-time objects as a function of at least one item of information, in particular the operating mode information.

An example device for controlling a computer system having at least two execution units, a switchover device and a comparator may advantageously be employed, a switchover taking place between at least two operating modes, and a first operating mode corresponds a compare mode, and a second operating mode corresponds to a performance mode, characterized in that an arrangement is included by which at least one set of run-time objects is defined, and a control program is provided, in particular a scheduler, which allocates resources of the computer system to the run-time objects as a function of an item of operating mode information.

An example device may advantageously be employed in which the arrangement by which at least one set of run-time objects is defined is embodied as a memory device

An example device may advantageously be employed by which the arrangement by which at least one set of run-time objects is defined is realized in that an item of information assignable and/or assigned to the run-time objects is stored in a defined memory region.

An example device may advantageously be employed in which the device is designed in such a way that at least one identifier is assigned to each run-time object of the defined set, and the identifier assigns at least the two operating modes to the run-time object.

An example device may advantageously be employed in which the device is designed in such a way that the items of information regarding an instantaneous operating mode of the computer system are available and the control program takes these into account in allocating the resources.

An example device may advantageously be employed in which the device is designed in such a way that items of information regarding a future operating mode of the computer system are available and the control program takes these into account in allocating the resources.

An example device may advantageously be employed in which the device is designed in such a way that the control program evaluates the identifier.

An example device may advantageously be employed in which the device is designed in such a way that the control program assigns at least one priority to the run-time objects as a function of at least one item of information, in particular the operating mode information.

The example methods and devices are advantageously included in a computer system.

### BRIEF DESCRIPTION OF THE DRAWINGS

FIG. 1 is a generalized representation of a switchover and compare unit.

FIG. 2 shows the main components of the example method according to the present invention.

FIG. 3 shows a broadened form of the present invention, including a scheduler.

FIG. 4 illustrates a multiprocessor system having two execution units.

### DETAILED DESCRIPTION OF EXAMPLE EMBODIMENTS

In the following text an execution unit may denote both a processor/core/CPU, as well as an FPU (floating point unit), a DSP (digital signal processor), a co-processor or an ALU (arithmetic logical unit).

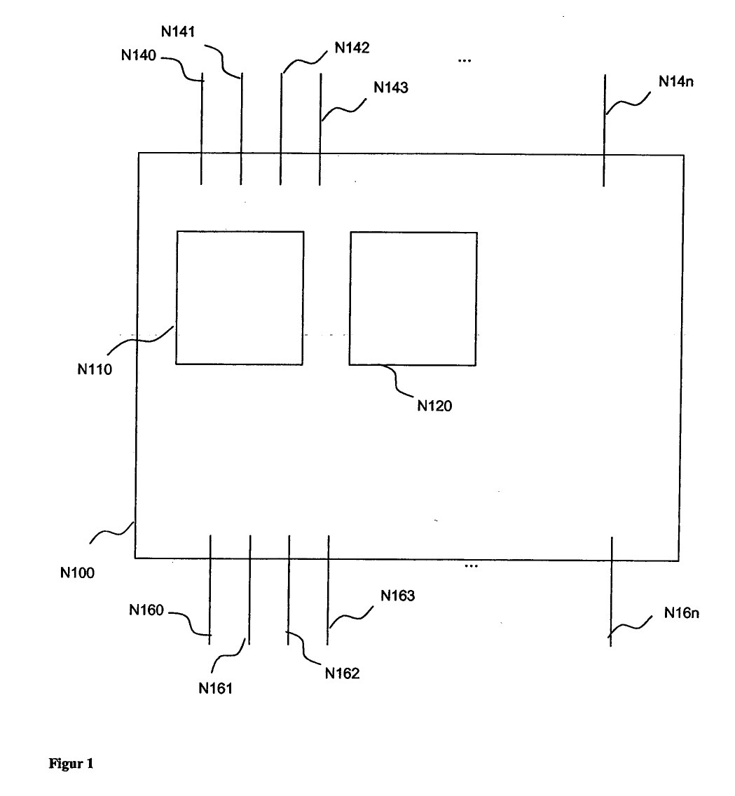

The present invention relates to a multiprocessor system W100, which is shown in FIG. 4 and has at least two execution units W110a, W110b, one compare unit W120, and one switchover unit W150. The principle of a switchable multi-processor system is described in this figure with the aid of a two-processor system. Accordingly, the general situation of a switchover and compare unit for more than two execution units is described in FIG. 1. The example embodiments of the present invention relate to the general situation with two or more execution units. The execution units in FIG. 4 are each connected via an optional intermediate memory W111a, W111b with a compare unit W120 and a switchover unit W150. Switchover unit W150 has at least two outputs to two system interfaces W130a, W130b. Registers, memories or peripherals such as digital outputs, digital-to-analog converters and communication controllers are able to be controlled via these interfaces. This multiprocessor system is able to be operated in at least two operating modes, a compare mode CM and a performance mode PM. In a performance mode, different instructions, program segments or programs are executed in parallel in the different execution units. The compare unit is deactivated in this operating mode. In this operating mode, switchover unit W150 is configured such that each execution unit is connected via the optional intermediate memory to one of the system interfaces W130a, W130b. A result of an execution unit is able to be written to a memory W170 via the system interfaces, or it may be output on a periphery module W180, W190. A periphery module can be, for example, an analog-to-digital converter or a communication controller of a communication system (e.g. SPI, LIN, CAN, FlexRay). There are several possibilities for deactivating the compare unit. First of all, a signal may be carried to the comparator, which activates or deactivates it. To that end, an additional logic, which is able to accomplish this, must be inserted in the comparator. Another possibility is to supply no data to be compared to the comparator. A third possibility is to ignore the error signal of the comparator on the system level. Moreover, one may also interrupt the error signal itself. What all the possibilities have in common is that they generate in the system a state in which it does not matter if there is a difference between two or more pieces of data that will potentially be compared. If this state is reached through a measure in the comparator or its input or output signals, then the comparator is labeled as passive or deactivated. In a compare mode, identical or substantially similar instructions, program segments or programs are processed in both execution units W110a, W110b. The output signals of the execution units are routed via optional intermediate memories W111a, W111b to compare unit W120 and to switchover unit W150. In the compare unit, both pieces of data are checked for agreement. After the comparison has been carried out, the switchover unit is informed via a status signal W125 whether this switchover unit can output one of the consistent results to one of the system interfaces or whether it must block the signal due to a detected discrepancy in the results. In this case, the compare unit can output an optional error signal W155. This error signal may also be output by the switchover unit (W156) instead of by the compare unit. In this context, the switchover is triggered either by the execution of special switchover instructions, special instruction sequences, explicitly identified instructions or by the access to a specific memory address by at least one of the execution units of the multiprocessor system.

In FIG. 1, a generalized development of a switchover and compare unit is now shown, as it should preferably be used. Of the n execution units to be considered, n signals N140, . . . , N14n are transmitted to switchover and compare component N100. From these input signals, this component is able to generate up to n output signals N160, . . . , N16n. In the simplest case, the “pure performance mode”, all signals N14i are routed to the corresponding output signals N16i. In the opposite, limiting case, the “pure compare mode,” all signals N140, . . . , N14n are routed to precisely only one of output signals N16i.

This figure illustrates how the various possible modes may be produced. To this end, the logic component of a switching logic N110 is included in this figure. This component does not have to exist as a separate component. What is crucial is that the functions described be realized in the system. Switching logic N110 first of all determines how many output signals there actually are. It also determines which of the input signals contribute to which of the output signals. In this context, one input signal may contribute to precisely one output signal. Formulated mathematically, the switching logic thus defines a function that assigns one element of the set {N160, . . . , N16n} to each element of the set {N140, . . . , N14n}.

Processing logic N120 then specifies for each of the outputs N16i, in what form the inputs contribute to this output signal. This component, as well, does not necessarily need to exist as a separate component. Decisive, again, is that the described functions be realized in the system. To describe the different possible variations exemplarily, it is assumed, without limiting universality, that output N160 is generated by signals N141, . . . , N14m. If m=1, this simply corresponds to the signal being switched through; if m=2, then signals N141, N142 are compared. This comparison may be implemented synchronously or asynchronously; it may be performed on a bit-by-bit basis, or for significant bits only, or also using a tolerance range.

In the case that m>=3, a plurality of options is provided. One first option provides for comparing all of the signals, and, in response to the presence of at least two different values, for an error to be detected, which may optionally be signaled. A second option provides for making a k-out-of-m selection (k>m/2). This may be implemented through the use of comparators. An error signal may optionally be generated if one of the signals is determined to be deviant. A possibly differing error signal may be generated if all three signals are different. A third option provides for supplying these values to an algorithm. This may take the form of generating an average value, a median value, or of using a fault-tolerant algorithm (FTA), for example. Such an FTA is based on deletion of the extreme values of the input values and on a type of averaging of the remaining values. This averaging may be performed for the entire set of the remaining values or preferably for a subset that is easily formed in HW. In such a case, it is not always necessary to actually compare the values. In the averaging operation, it is merely necessary to add and divide, for example; FTM, FTA or median value generation require partial sorting. If appropriate, a fault signal may optionally be output here as well, given sufficiently high extreme values. For the sake of brevity, these various mentioned options for processing a plurality of signals to form one signal are described as compare operations.

Thus, the task of the processing logic is to establish the exact form of the comparison operation for each output signal, and thus also for the corresponding input signals. The combination of the information of switching logic N110 (i.e., the function named above) and of the processing logic (i.e., the establishment of the comparison operation per output signal, i.e., per functional value) is the mode information, and this determines the mode. Generally, this information is naturally multi-valued, i.e., not representable by only one logic bit. Not all theoretically possible modes are practical in a given implementation; preferably, the number of permitted modes will be limited. It is important to note that, in the case of only two execution units, where there is only one compare mode, the entire information may be condensed onto only one logic bit.

A switch from a performance mode to a compare mode is generally characterized in that execution units, which are mapped to different outputs in the performance mode, are mapped to the same output in the compare mode. This is preferably implemented by providing a subsystem of execution units, in which, in the performance mode, all input signals N14i, which are to be considered in the subsystem, are directly switched to corresponding output signals N16i, while, in the compare mode, they are all mapped to one output. Alternatively, such a switchover operation may also be implemented by altering pairings. This demonstrates that, generally, it is not possible to speak of the performance mode and the compare mode, although, in one specific embodiment of the present invention, the number of permitted modes may be limited in such a way that this general case does apply. However, it is always possible to speak of a switch from performance mode to compare mode (and vice versa).

Software-controlled switchover operations between these modes may be carried out dynamically during operation. In such a case, the switchover operation is triggered by the execution of special switchover instructions, special instruction sequences, explicitly identified instructions or in response to the accessing of specific addresses by at least one of the execution units of the multiprocessor system.

First, the basic idea is to be described. One approach for coordinating the switchover between different modes of the processor is to group different software modules so as to form run-time objects, to which the operating system then specifies computing time. Among others, each of these run-time objects receives an identifier as to the mode in which this run-time object is to be executed. When the operating system assigns computing time to this run-time object, then the mode change is simultaneously initiated by the operating system.

Core ideas of the present invention are:

A special identifier, which is analyzed by the scheduler, is assigned to a run-time object. Furthermore, the scheduler utilizes the information as to which mode the system is currently operating in and, optionally, additional configuration information that provide statements about the mode in which the system is expected to be in the future. It utilizes this information for implementing a priorization regarding the possible run-time objects and decides which run-time object will be allocated computing time. This makes it possible to avoid a frequent mode switch.

In another specific embodiment, the run-time object is assigned a special identifier, which specifies that the run-time object is to be, or is able to be, executed in different modes in alternation. Optionally, it may also be indicated after how many activations in one of the modes a switch is to be made to another mode, and to which mode. In one special specific embodiment, a run-time object receives a special identifier, which specifies that, following at least n executions in the one mode, it will be executed at least once (m-times) in another mode. In another specific embodiment thereof, a run-time object receives a special identifier, which specifies that, following at least n executions in the one mode, it will be executed at least once (m-times) in another. The identifiers are advantageously stored in memories.

The scheduler may optionally also employ a strategy that utilizes this information for implementing a suitable priorization.

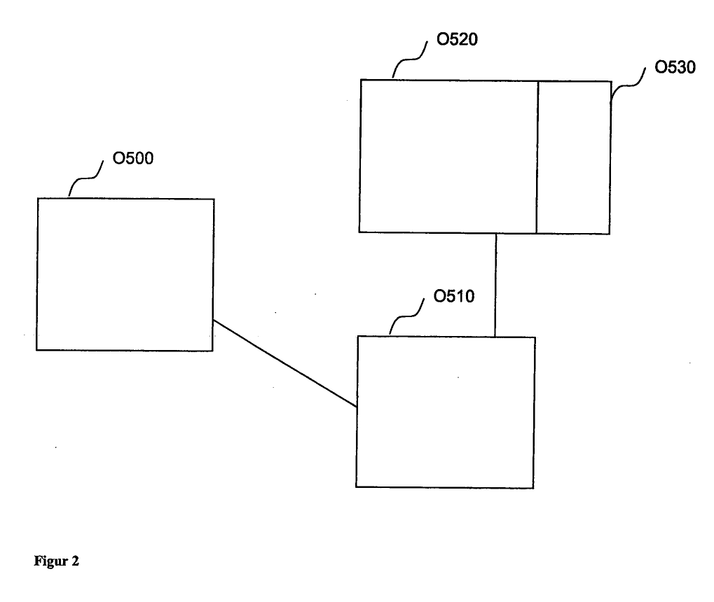

FIG. 2 describes components of the example method according to the present invention. O500 denotes the processing unit having a plurality of execution units and a switchover and compare unit. O520 denotes the number of run-time objects that compete for computing time at a given moment. Often, the status description “ready” is used to describe such run-time objects. O520 thus denotes the number of run-time objects that are in the “ready” state at a given time. O530 denotes the identifiers assigned to these run times. Scheduler O510 uses, among others, the information about the current mode of the processing unit and the identifiers of the run-time objects in the ready state in order to implement a priorization of these run-time objects at a given moment and to allocate computing time to the run-time object then having the highest priority.

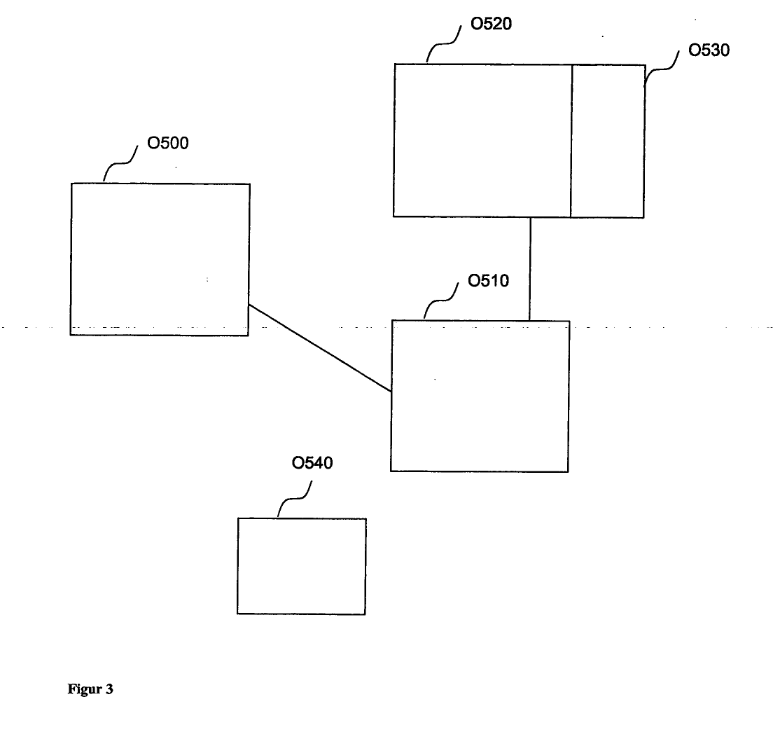

FIG. 3 depicts a further specific embodiment. Components O500, O510, O520, O530 have the same meaning as in FIG. 2. In addition, configuration information O540 is included. This information is optionally utilized by scheduler in addition, in order to implement the priorization.

A suitable priorization scheme may be realized by, for instance, giving run-time objects that are able to be calculated in the current mode a higher priority or a priority increase. This makes it possible to reduce the frequency of mode switchovers and thus to achieve better utilization of the capacity of the processing unit.

In another specific embodiment, the identifier scheme of the run-time object may be expanded in such a way that, in addition, an item of information is included which specifies that the run-time object is to, or can be, executed in alternation in different modes. It may optionally also be indicated after how many activations in one of the modes a switch is to be made to another mode, and to which mode. In one special specific embodiment, a run-time object is provided with a special identifier, which specifies that, following at least n executions in the one mode, it will be executed at least once (m-times) in another mode. In an additional specific embodiment, a run-time object is provided with a special identifier, which specifies that, following at least n executions in the one mode, it will be executed at least once (m-times) in another mode. The identifiers are advantageously stored in memories.

The scheduler may optionally also employ a strategy that utilizes this information for implementing a suitable priorization. In this case, for instance, a run-time object in the ready state, which is actually executable in the current mode but which must be reactivated in the current mode only in the more distant future, may receive a lower priority. Another potential strategy would be to assign an especially high priority to a run-time object that must be executed in the current mode only especially rarely, only in those cases where this mode is assumed only very rarely. This latter information may be gathered from the configuration information, for example.

Thus, a method and a device are described for controlling a processing unit (of a processor system) having a plurality of execution units and a switchover and compare unit for switching between at least two operating modes of the processor system, a set of run-time objects being defined, a scheduler being provided which assigns resources to these run-time objects, and the scheduler evaluating the current mode information during operation.

The run-time objects themselves are assigned at least one identifier, which includes information about the mode assigned to the run-time objects and which is evaluated by the scheduler.

1-15. (canceled)

16. A method for controlling a computer system having at least two execution units, comprising:
switching between at least two operating modes, and a first operating mode corresponding to a compare mode, and a second operating mode corresponding to a performance mode;
defining at least one set of run-time objects; and
assigning, by a control program, resources of the computer system to the run-time objects as a function of an item of operating mode information, the control program corresponding to a scheduler.

17. The method as recited in claim 16, wherein each run-time object of the defined set is assigned at least one identifier, and the identifier assigns at least the two operating modes to the run-time object.

18. The method as recited in claim 16, wherein information regarding a current operating mode of the computer system is available and the control program takes the information into consideration in allocating the resources.

19. The method as recited in claim 16, wherein information regarding a future operating mode of the computer system is available and the control program takes the information into consideration in allocating the resources.

20. The method as recited in claim 17, wherein the control program evaluates the identifier.

21. The method as recited in claim 16, wherein the control program assigns at least one priority to the run-time objects as a function of the item of operating mode information.

22. A device for controlling a computer system having at least two execution units, a switchover device and a comparator, a switchover taking place between at least two operating modes, and a first operating mode corresponding to a compare mode, and a second operating mode corresponding to a performance mode, the device comprising:
an arrangement adapted to define at least one set of run-time objects; and
a control program adapted to assign resources of the computer system to the run-time objects as a function of an item of operating mode information, the control program including a scheduler.

23. The device as recited in claim 22, wherein the arrangement by which at least one set of run-time objects is defined, is a memory device.

24. The device as recited in claim 22, wherein the arrangement by which at least one set of run-time objects is defined is realized in that an item of information at least one of assignable and assigned to the run-time objects is stored in a defined memory location.

25. The device as recited claim 22, wherein the device is designed in such a way that at least one identifier is assigned to each run-time object of the defined set, and the identifier assigns at least the two operating modes to the run-time object.

26. The device as recited in claim 22, wherein the device is configured in such a way that information regarding a current operating mode of the computer system is available and the control program takes the information into consideration in allocating the resources.

27. The device as recited in claim 22, wherein the device is configured in such a way that information regarding a future operating mode of the computer system is available and the control program takes the information into consideration in allocating the resources.

28. The device as recited in claim 26, wherein the device is designed in such a way that the control program evaluates the identifier.

29. The device as recited in claim 22, wherein the device is configured in such a way that the control program assigns at least one priority to the run-time objects as a function of the item of operating mode information.

30. A computer system, comprising:
at least two execution units;
a switchover device;
a comparator, the switchover device switching the computer system between at least two operating modes, a first operating mode corresponding to a compare mode, and a second operating mode corresponding to a performance mode;
an arrangement adapted to define at least one set of run-time objects; and
a scheduler adapted to assign resources of the computer system to the run-time objects as a function of an item of operating mode information.
